(19) United States
(12) Patent Application Publication
(10) Pub. No.: US 2026/0013666 A1
(43) Pub. Date: Jan. 15, 2026

(54) GRILLING DEVICE

(71) Applicant: Adam Peterson, Rockton, IL (US)

(72) Inventor: Adam Peterson, Rockton, IL (US)

(21) Appl. No.: 19/264,769

(22) Filed: Jul. 9, 2025

Related U.S. Application Data
(60) Provisional application No. 63/669,093, filed on Jul. 9, 2024.

(51) Int. Cl. A47J 37/07; A23B 4/052; A23L 5/10; F24C 1/02; F24C 3/00; F24C 3/10

(52) U.S. Cl. CPC A47J 37/0713; A23B 4/052; A23L 5/15; A47J 37/0709; A47J 37/0786; F24C 1/02; F24C 3/002; F24C 3/103

(57) ABSTRACT

The present invention is a grilling device that can be placed inside the cooking cavity of a larger grill, cooker, smoker, or similar, allowing the larger non-propane powered cooker to utilize alternative fuel sources such as propane, natural gas, or electric heat as configured by the grilling device.

### CROSS REFERENCE TO RELATED APPLICATIONS

This application claims the benefit of priority to U.S. Provisional Application No. 63/669,093 filed Jul. 9, 2024, which is hereby incorporated by reference.

### BACKGROUND OF THE INVENTION

Outdoor cooking has been a fast-growing area of interest in recent years. This popularity has led to the wider adoption of various types of cooking devices, such as Kamado style grills. However, these grills suffer many drawbacks that limit their usefulness. These grills and similar smokers typically use charcoal, wood, pellets, or electricity as a fuel source, which are often not suitable for cooking food quickly. Cookers which use these types of fuel sources often require more effort to ignite, more time to obtain the desired temperature, and more attention to maintain that temperature, as opposed to cookers which use other fuel sources such as propane, natural gas, or electric heat.

Therefore, a need exists for a novel grilling device capable of use with a variety of Kamado grills, or other cooking vessels. There is also a need for the grilling device to possess a body style that allows it to be utilized independent from another vessel, if desired. This increases the device's usability by allowing the user to remove it from the larger cooker, allowing both the invention as well as the Kamado grill to be used simultaneously, thus increasing the cooking surface area when needed for larger gatherings. Alternatively, a user can take advantage of its portability and use it fully remote from a Kamado grill by taking it to a campsite, park, or tailgating event. Finally, there is a need for the grilling device to be self-contained, allowing a greater level of safety, as well as the ability to trap and contain any grease or food debris, allowing the accompanying Kamado grill to stay cleaner and extend its life.

### BRIEF SUMMARY OF THE INVENTION

To meet the needs noted above and others, the present disclosure provides a grilling device that is conveniently used in conjunction with commercial cookers and smokers. When used in conjunction with commercial cookers, the grilling device allows the user to cook with fuel not normally supplied to the commercial cooker. For example, the cooker uses a first fuel type, such as charcoal, wood, pellets, or electricity. The grilling device utilizes a second fuel type that is different than that of the cooker. In one embodiment, the second fuel type is a gaseous fuel such as propane or natural gas. In other embodiments, the second fuel type is electricity. Therefore, the grilling device allows the user to expand the functionality of their commercial cooker by providing alternative fuel sources beyond those envisioned in the factory designed cooker.

The grilling device is equipped with a collar. The collar is designed to closely mate with a lid of the factory cooker. This creates a sealed cooking chamber to retain heat when the grilling device is used in conjunction with the factory cooker. In one embodiment, the collar has an upper surface and a lower surface that are non-parallel, allowing the collar to mate with a hinged lid. In a further embodiment, the upper surface and the lower surface of the collar are parallel, allowing the collar to mate with a detachable lid.

The grilling device is also used independently of a commercial cooker. The grilling device is equipped with a bowl, such as a metallic bowl. The bowl has a bowl bottom. Attached to the bowl bottom is a trim ring. The bowl and bowl bottom create an independent cooking chamber to contain heat generated by the grilling device. The bowl and bowl bottom are supported by the trim ring which allows the grilling device to be placed on a tabletop or the ground. The separate cooking chamber created by the bowl and bowl bottom allows the cooking device to be self-contained and used independently of the enclosure provided by the commercial cooker.

In one embodiment, the grilling device is configured to be coupled to a cooker. The cooker utilizes a first fuel type. The grilling device comprises a bowl, a heating apparatus, and a collar. The heating apparatus utilizes a second fuel type different than the first fuel type. The collar surrounds the bowl and houses components of the heating apparatus. The collar includes a lower surface configured to engage a sealing rim of the cooker and an upper surface configured to engage a lid of the cooker.

The heating apparatus may further include a fuel system, a heater, and a control system. The fuel system is connected to the second fuel type and positioned within the collar. The heater is positioned within the bowl and connected to the fuel supply system. The control system is connected to the fuel supply system and configured to control a flowrate of the second fuel type provided to the heater.

The bowl may further include a sidewall having an upper edge and a lower edge. A cooking surface is positioned adjacent to the upper edge of the sidewall.

The bowl may further include a bowl bottom that is connected to the sidewall adjacent the lower edge, and wherein the bowl bottom is sloped downward to an aperture.

The grilling device may further include a trim ring attached to the lower edge of the sidewall.

The collar may further be provided at a first elevation, wherein the heater is provided at a second elevation below the first elevation, and wherein the fuel supply system is configured to direct the second fuel type to the heater at the second elevation. In some embodiments, the first elevation of the collar may further be spaced from the second elevation of the heater by up to 3 inches. In one embodiment, the first elevation of the collar is spaced from the second elevation of the heater by 2.83 in.

In one embodiment, the fuel supply system may further include tubing and a valve and the heater may further include a gas burner. In a still further embodiment, the fuel supply system may further include an electrical supply cord and the heater may further include an electric heating element.

In an embodiment utilizing the gas burner, the gas burner may further include an ignition system. The ignition system may further comprise a push button igniter, an electrode wire, and a spark generating electrode. The push button ignitor is connected to the electrode wire. The electrode wire is connected to the spark generating electrode, which is mounted near the burner.

In one embodiment, the lower surface and the upper surface of the collar may be non-parallel. In a still further embodiment, the lower surface and the upper surface of the collar may be parallel.

The first fuel type may further be one of charcoal, wood, pellets, or electricity.

The second fuel type may further be one of gaseous fuel or electricity.

The grilling device may further include one or more side shelves attached to the collar. The grilling device may further include side shelves which attach to a side shelf bracket on the collar, and each side shelf is configured to move between a stored position and an operable position.

The grilling device may further allow the bowl to receive an airflow from a flavor-enhancing chamber in the cooker, wherein the airflow comprises a flavor-enhancing material absorbed in the flavor-enhancing chamber.

A method of cooking with the grilling device includes: positioning a grilling device comprising a bowl, a heating apparatus, and a collar surrounding the bowl in a cooker. A lower surface of the collar will engage a sealing rim of the cooker. The heating apparatus will be operated to provide heat. A lid of the cooker will be closed such that an upper surface of the collar engages the lid of the cooker.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a perspective view from above of a grilling device according to an embodiment of the present disclosure.

FIG. 2 is a perspective view from below of the grilling device of FIG. 1.

FIG. 3 is a top view of the grilling device of FIG. 1.

FIG. 4 is a primary upper perspective view of the grilling device of FIG. 1.

FIGS. 5A and 5B are left and right side views of the grilling device of FIG. 1.

FIG. 6 is a front view of the grilling device of FIG. 1.

FIGS. 7A and 7B are left and right side views of an alternative embodiment of a collar for use with the grilling device of FIG. 1.

FIG. 8 is an exploded view of the grilling device of FIG. 1.

FIGS. 9-12 are perspective views illustrating the insertion of the grilling device into a larger cooker according to an embodiment of the present disclosure.

FIG. 13 is a side sectional view of the grilling device placed in the larger cooker.

FIG. 14 is a cutaway perspective view of the grilling device placed in the larger cooker.

FIG. 15 is an upper perspective view of the grilling device of FIG. 1.

FIGS. 16-17 are perspective views illustrating the insertion of the grilling device of FIG. 1 into a tabletop base.

FIGS. 18-20 are perspective views illustrating the insertion of the grilling device of FIG. 1 into a floor standing base.

FIGS. 21-22 are perspective views illustrating the insertion of a griddle top into the grilling device of FIG. 1.

FIGS. 23-25 are partially exploded perspective views of an electric embodiment of the grilling device.

FIGS. 26-29 are perspective views illustrating the attachment of foldable side shelves to the grilling device of FIG. 1.

FIGS. 30-32 are perspective views illustrating the attachment of collapsible legs to the grilling device of FIG. 1.

### DETAILED DESCRIPTION OF THE INVENTION

The following description is provided as an enabling teaching of exemplary embodiments of a system and method for making and using an insertable portable cooking grill. Those skilled in the relevant art will recognize that changes can be made to the embodiments described, while still obtaining the beneficial results. It will also be apparent that some of the desired benefits of the embodiments described can be obtained by selecting some of the features of the embodiments without utilizing other features. In other words, features from one embodiment or aspect may be combined with features from other embodiments or aspects in any appropriate combination. For example, an individual or collective features of method aspects or embodiments may be applied to apparatus, product or component aspects, or embodiments and vice versa. Accordingly, those who work in the art will recognize that many modifications and adaptations to the embodiments describe are possible and may even be desirable in certain circumstances and are part of the invention. Thus, the following description is provided as an illustration of the principles of the embodiments and not in limitation thereof.

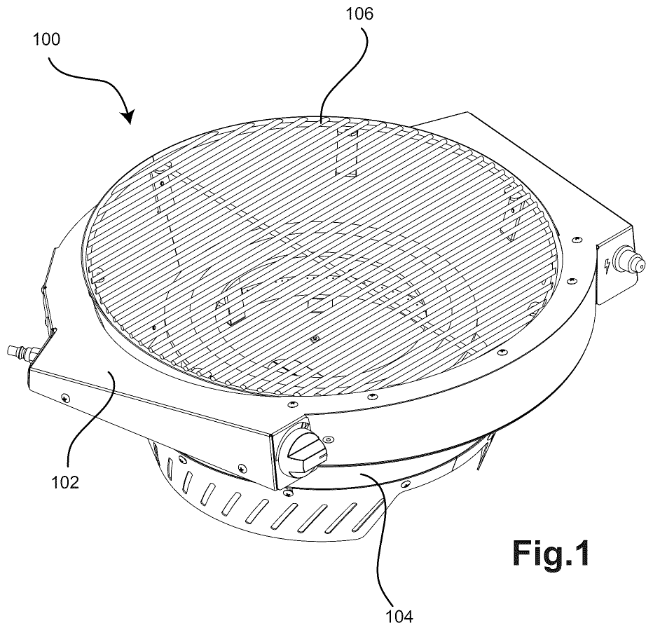

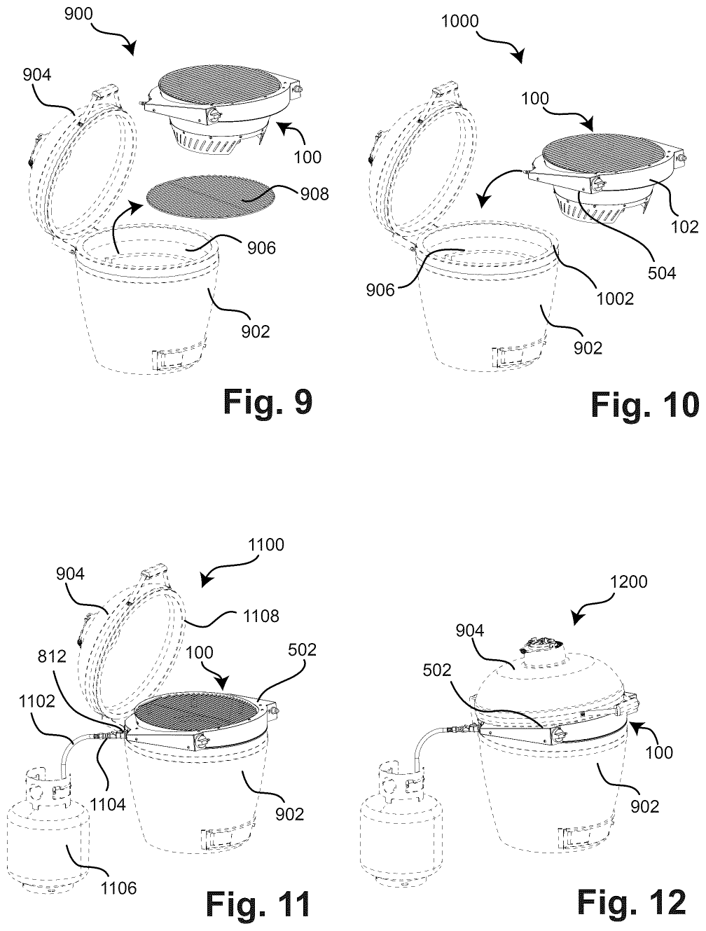

FIGS. 1-8 depict a grilling device (100) according to the present disclosure. Referring to FIGS. 9-12, the grilling device (100) can be inserted into a cooker. The purpose of the invention is to expand the usefulness of a factory supplied cooker. This is accomplished by supplementing the fuel sources the factory supplied cooker is capable of utilizing.

Referring to FIG. 1, the grilling device (100) includes a bowl (104) connected to a collar (102). The collar (102) is mechanically attached to the bowl (104) and surrounds a circumference of the bowl (104). In one embodiment, one or more grate brackets are positioned on an inner surface of the bowl (104) and configured to support a wire grate (106) or other cooking surface of the grilling device (100).

In some embodiments, the bowl is made of metal or another material suitable for containing fire, such as brick or stone. Further, in some embodiments, the bowl may have a rounded or semispherical shape. In other embodiments, the bowl may have any suitable shape.

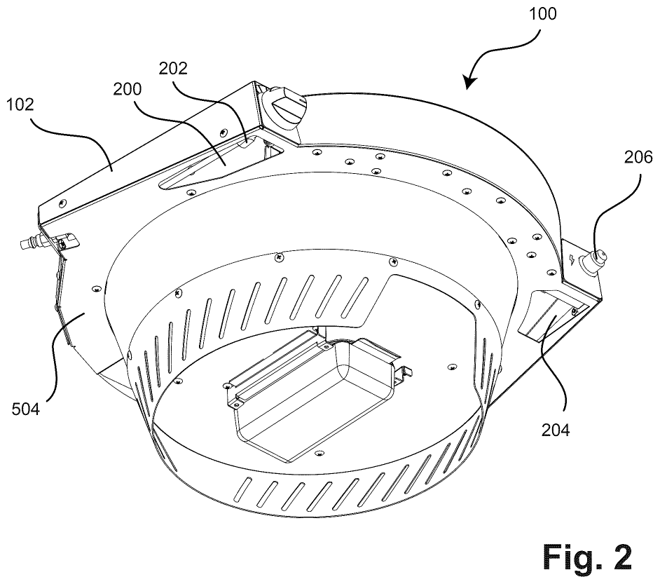

FIG. 2 shows a lower surface (504) of the collar (102) with a valve access cavity (200) to allow for assembly, insertion, servicing, or removal of a fuel supply system (202). The lower surface (504) of the collar (102) also includes an igniter access hole (204), allowing for the assembly, insertion, servicing, or removal of an ignition system (206).

FIG. 3 shows the grilling device (100) with the wire grate (106) in place. The collar (102) includes first and second housing structures on the left and right sides of the grilling device (100) to house a fuel supply system (202) and an ignition system (206). Additionally, the first and second housing structures extend laterally beyond the outer shape of the cooker in which the grilling device (100) is positioned such that the housing structures provide grasping points, allowing the user to grip the grilling device (100) for insertion, removal, or for transport.

The fuel supply system (202) directs and controls the flowrate of fuel provided to a heater positioned in the bowl (104). In one embodiment, the fuel system uses a gaseous fuel such as natural gas or propane which is ignited in a burner type heater. In another embodiment, the fuel system uses electricity and an electric heating element for the heater.

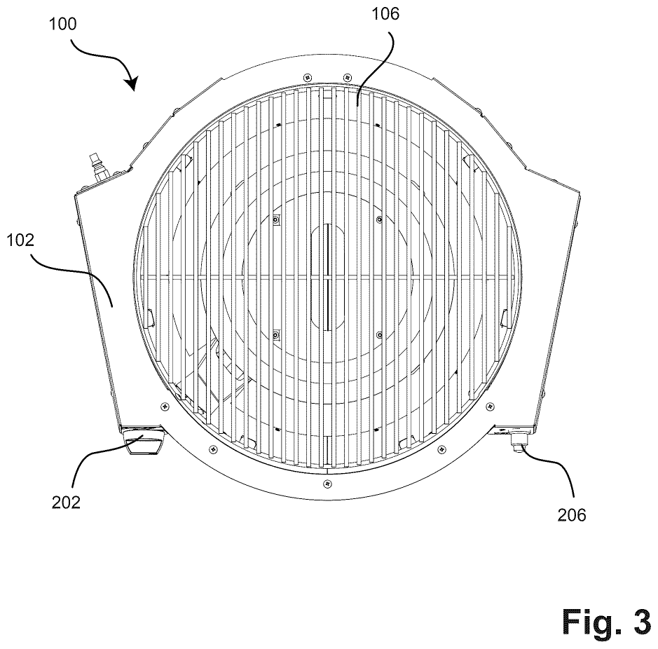

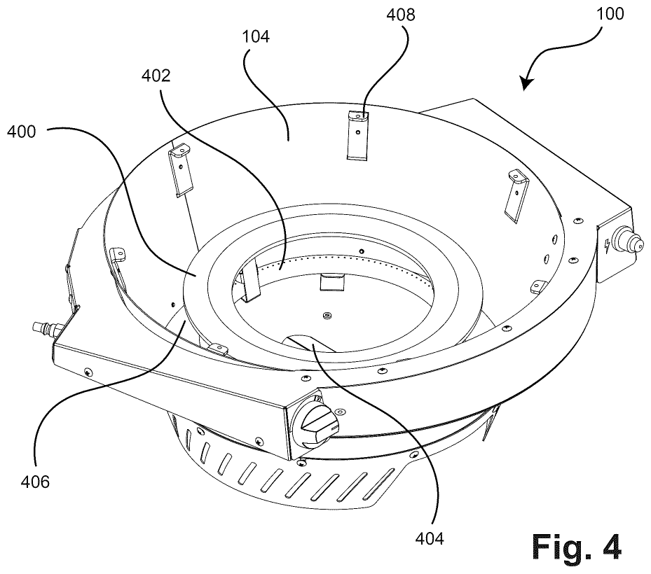

Referring to FIG. 4, the grilling device (100) includes a heat tent (400) positioned above a gas burner (402). Also shown in this image is a grease cover (404) positioned over an aperture on a bottom (406) of the bowl (104). Further shown are the one or more angle grate brackets (408) that are assembled in place around the perimeter of the bowl (104).

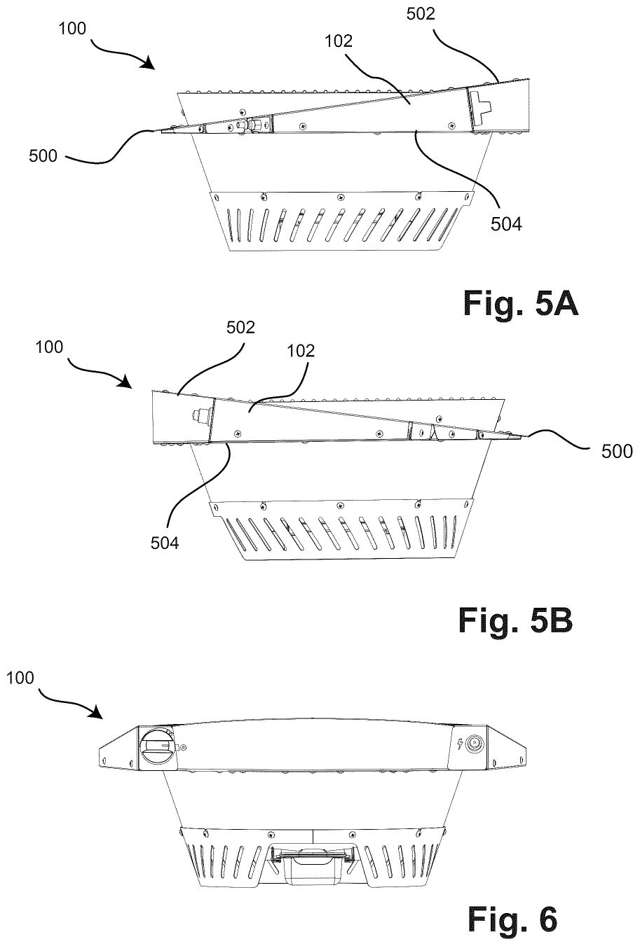

FIGS. 5A and 5B show the upper surface and the lower surface of the collar (102) in a non-parallel arrangement (500). The non-parallel arrangement forms a self-contained, tightly sealed atmosphere between a mating cooker (902) equipped with a hinged lid (904) and the grilling device (100). The tight seal prevents heat from escaping during the cooking process. The non-parallel arrangement (500) provides a shape that closely aligns the upper surface (502) of the collar (102) with a hinged lid (904) of the mating cooker (902) and the lower surface (504) of the collar (102) with a sealing rim (1002) of the mating cooker (902).

FIG. 6 shows the first and second housing structures on the left and right sides of the grilling device. In some instances, a mating cooker (902) may have accessories or surfaces flush with, or extend slightly outward beyond, the mating cooker's (902) perimeter sealing edge (1002), which may interfere with the ability to remove the grilling device (100). The first and second housing structures function as a gripping point to allow for easy removal of the grilling device (100).

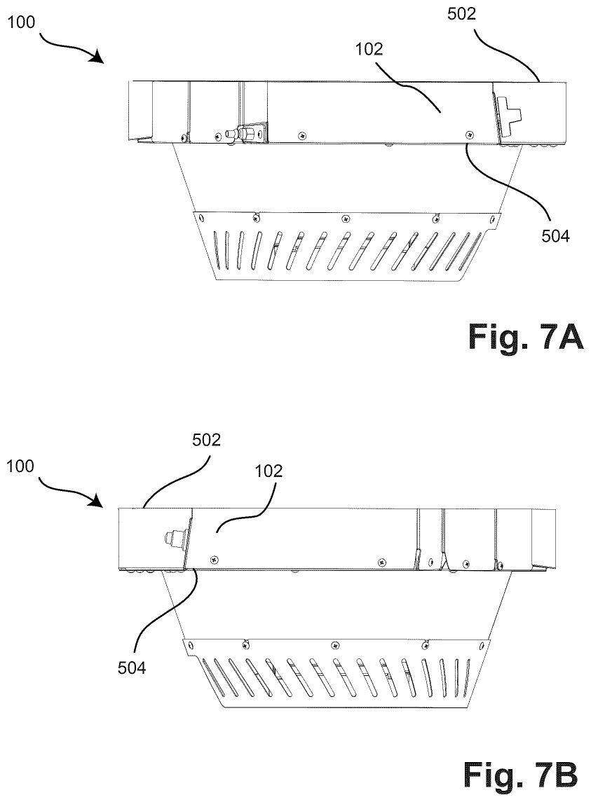

FIGS. 7A and 7B show an alternative embodiment of the collar where the upper surface (502) and the lower surface (504) of the collar (102) are in a parallel arrangement. While the non-parallel arrangement will be most beneficial in the cooker (902) with the hinged lid (904), the embodiment shown in FIGS. 7A and 7B can be used with cookers where the lid (904) is either completely detachable or lifted vertically in a straight, downward-then-upward motion relative to the mating surface of the cooker (902). In this embodiment, the upper surface (502) and the lower surface (504) are parallel, providing a shape that closely aligns the upper surface (502) of the collar (102) with the lid (904) of the mating cooker (902) and the lower surface (504) of the collar (102) with a sealing rim (1002) of the mating cooker (902).

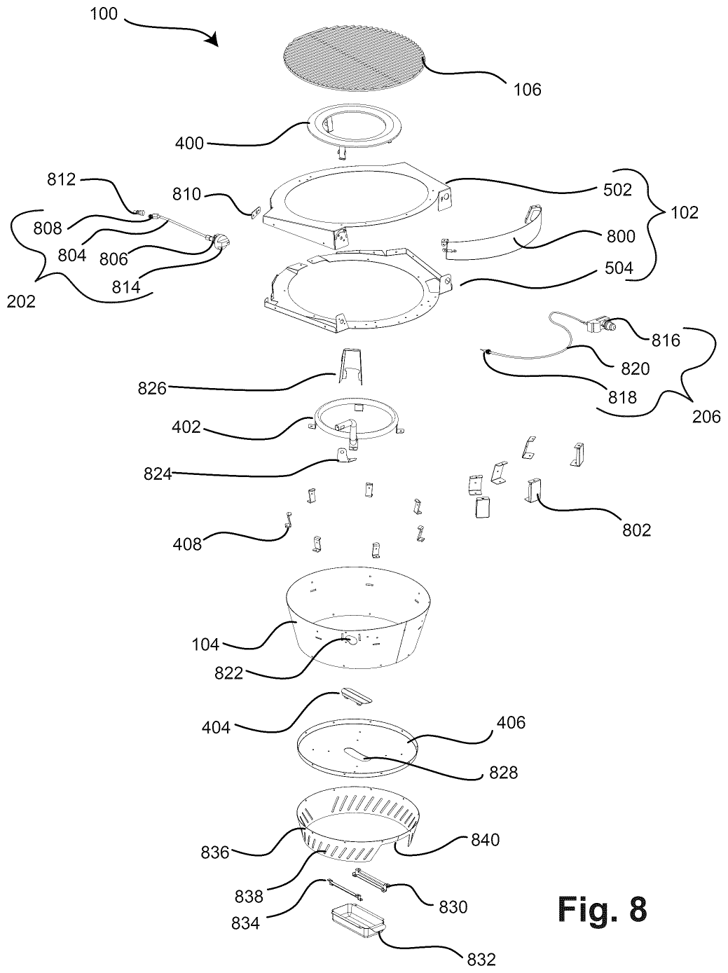

FIG. 8 shows the grilling device (100) equipped for use with a gaseous fuel such as propane, natural gas, or any other gaseous fuel capable of providing heat for cooking. In this embodiment, the grilling device (100) is equipped with the collar (102) comprising the front panel (800), upper surface (502) and the lower surface (504) frame part. Within the collar (102) is a plurality of sheet metal frame supports (802). The sheet metal frame supports (802) are placed in between the upper surface (502) and the lower surface (504) to provide structural support. When joined, these parts enclose the fuel supply system (202) and the ignition system (206). Joining the collar (102) to the bowl (104) are a plurality of angle grate brackets (408), which also serve as a resting point for the wire grate (106).

The fuel supply system (202) comprises a fuel supply tube (804) attached to a fuel supply valve (806). A threaded connector (808) is secured to the rear end fuel supply tube (804). The threaded connector (808) is routed through a hole in a rear valve support panel (810). When the valve support panel (810) is connected to the outer, rear surface of the collar (102), the threaded male portion of the threaded connector (808) lies external to the assembly. Attached to the male threads on the threaded connector (808) is the female threaded portion of a threaded quick connect stem (812). The quick connect stem (812) is located on the grilling device (100) at a point which will avoid interference with any mating accessories, components, or the normal opening and closing action of a mating grill (900). Internal to the bowl (104) is the tubular burner (402) which acts as a conduit to supply gaseous fuel. The fuel system (202) flow path allows the burner (402) to be placed below the wire grate (106), allowing the cooking surface elevation of the grilling device (100) to be similar to the cooking surface elevation of the mating cooker (902). While the burner (402) is shown as circular, other burner embodiments may be utilized, such as burners that extend in a straight horizontal line. Additionally, multiple separately controlled burners may be utilized to support different heat zones within the grilling device (100). The burner (402) is elevated off the surface of the bowl bottom (406) with brackets welded to the bottom side of the burner (402).

On the frontal surface of the collar (102) is a radially adjustable control system (814). The control system (814) is connected to the fuel supply valve (806). When the control system is rotated it will adjust the flow at which gaseous fuel is supplied to the burner (402). The control system may be a knob, dial, or any other method capable of adjusting flow.

The ignition system (206) comprises a push button igniter (816), a spark generating electrode (818), and an electrode wire (820). When pressed, the push button igniter (816) sends an electrical current or pulse through the electrode wire (820), which is connected to the backside of the push button igniter (816) and delivers the current or pulse to the spark generating electrode (818). In one embodiment, one electrode wire runs through the collar (102) and continues through an opening (822) in the side of the bowl (104), down the interior wall of the bowl, and terminates at the spark generating electrode (818). The spark generating electrode (818) is secured to an electrode bracket (824). The spark generating electrode (818) is positioned with the tip of the spark generating electrode (818) near the outer surface of the burner (402). This proximity allows a spark to be generated when the push button igniter (816) is pressed. This spark ignites the gaseous fuel supplied through the fuel supply system (202) and burner (402). A burner neck cover (826) is placed over the electrode wire (820), the spark generating electrode (818), and the opening (822). The burner neck cover (826) helps to minimize inadvertent damaging of these components.

The bowl (104) includes a sidewall with an upper edge and a lower edge. A cooking surface is positioned near the upper edge. A bowl bottom (406) is connected to the lower edge. The bowl bottom (406) is gradually sloped downwards towards the center-point of the bowl bottom (406). The bowl bottom (406) can be mechanically attached to the lower edge circumferentially with fasteners. Alternative versions allow the bowl bottom (406) to be attached by means of welds, and in yet other versions these parts may be formed together as a single piece. The downwards slope of the bowl bottom (406) terminates into the aperture (828) at the center of the bowl bottom (406). The aperture (828) serves as the exit orifice for grease and debris which may accumulate from the cooking process.

Attached to the underside of the bowl bottom (406) are a pair of grease pan support brackets (830). The grease pan support brackets (830) are formed in such a way to hold the outer edges of a grease pan (832), while allowing it to be slidably removed from the grease pan support brackets (830). A rear flange (834) is folded on one edge of each grease pan support bracket (830) to prevent the grease pan (832) from unintentionally sliding in the rear direction.

A metal trim ring (836) is attached to the lower edge of the bowl bottom (406) and circumferentially to the bottom edge of the bowl (104). For instances where the grilling device (100) is utilized separately from an accompanying grill, smoker, or other accessory, the bottom of the trim ring (836) can be placed atop a table, counter, or the ground. When in use separate from an accompanying grill, the trim ring (836) serves to elevate the hot surface of the bowl (104) and bowl bottom (406) portions of the grilling device (100) from combustible or sensitive surfaces it may rest upon. Trim ring perforations or slits (838) act as a means of thermal diffusion between the hot surfaces and the resting surface of the grilling device (100). A front cutout (840) in the face of the trim ring (836) serves as an access area for the grease pan (832) to be removed.

In order to prevent grease flare-ups, deflect grease and food debris from falling onto the burner (402), and better distribute heat within the grilling device (100), the heat tent (400) is pressed onto the top of the burner (402) by use of welded brackets protruding from the underside of the angled top portion of the heat tent (400). Additional prevention of grease flare-ups is accomplished with the grease cover (404), which is positioned above the aperture (828) on the bowl bottom (406).

FIG. 9 shows a first step (900) of inserting the grilling device (100) into a larger vessel or cooker (902), such as a Kamado Grill. In preparing the cooker (902) to accept the grilling device (100), the lid (904) attached to the cooker (902) must first be lifted in order to gain access to an inner chamber (906) of the cooker (902). Next, a cooker wire grate (908), disposed on the inner edge of the cooker (902), is removed. In preferred embodiments, the cooker wire grate (908) is of similar or identical diameter as the wire grate (106) from the grilling device (100). This similar size allows for interchangeable use of either the cooker wire grate (908) or the wire grate (106) of the grilling device (100).

FIG. 10 shows a second step (1000) of inserting the grilling device (100) into the larger cooker (902). With the user grasping the first and second housing structures of the grilling device (100), the device is inserted into the inner chamber (906) of the cooker (902) until the lower surface (504) of the collar (102) is resting on the sealing rim (1002) of the cooker (902).

FIG. 11 shows a third step (1100) of inserting the grilling device (100) into the larger cooker (902). The figure shows the opened position of the cooker (902) with a propane hose (1102) and a quick connect gas coupling (1104) connected to the quick connect stem (812) on the rear of the grilling device (100). The opposite end of the propane hose (1102) is connected to a fuel supply tank (1106). This is the assembled stage at which the device is ready to be powered on and accept food for cooking. By lowering the lid (904), a sealing lip (1108) on the lid (904) presses onto the upper surface (502) of the grilling device (100).

FIG. 12 shows a fourth step (1200) of inserting the grilling device (100) into a larger cooker (902). Shown here is the cooker (902) with the lid (904) closed upon the upper surface (502) of the grilling device (100). This is the assembled stage at which the device is powered on and in the cooking process.

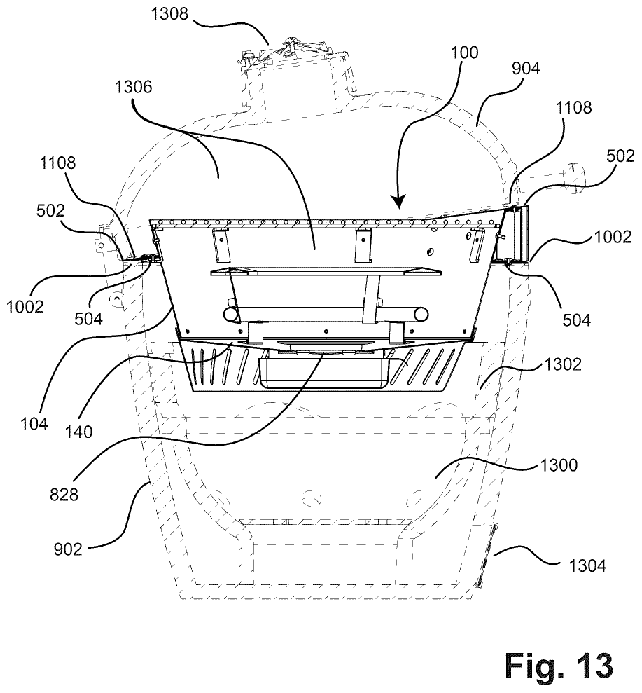

FIG. 13 shows a cutaway section view of the grilling device (100) positioned in the cooker (902). In the preferred embodiment, the bowl (104) is constructed from sheet metal and is of a continuous curved sidewall that is vertically angled in such a way as to allow for insertion into an accompanying cooker (902) without adversely interfering with typical structure or common factory parts found on the cooker (902), such as a firebox (1300) and a fire ring (1302). Therefore, insertion of the device can be achieved with little to no modification or alteration to the factory cooker (902), often only requiring the removal of the factory cooker wire grate (908).

Further shown in the cutaway section view is the sealing lip (1108) on the cooker lid (904) now resting upon the upper surface (502) of the grilling device (100). The sealing lip (1108) is in continuous contact with the perimeter of the grilling device (100). Similarly, the lower surface (504) of the grilling device (100) is now resting on the sealing rim (1002) of the cooker (902) creating a continuous seal around the vessel.

Typically, cooking devices require an amount of fresh air in order to properly function. When the grilling device (100) is being used inside a larger cooker (902), fresh air is introduced into a grilling chamber of the cooker by way of a fresh air vent (1304) located on the lower end of the cooker (902). The air then enters into a cooking chamber (1306) of the grilling device (100) through the aperture (828) located on the bowl bottom (406). Hot air generated by the cooking process is then allowed to exhaust through a top cap (1308) found on the lid (904) of the cooker (902).

In some embodiments, the cooker (902) may contain a flavor enhancing material within a flavor enhancing chamber. The flavor enhancing chamber is located below the grilling device (100) and within the firebox (1300) of the cooker (902). The flavor enhancing material may be any material capable of adding an aroma to the food being cooked in the grilling device (100). For example, the flavor enhancing material may be charcoal, wood, or wood pellets. As the airflow is drawn into the cooker firebox (1300) through the vent (1304), the air passes over the flavor enhancing material located within the flavor enhancing chamber. The airflow absorbs flavor and aroma from the flavor enhancing material. As the airflow is drawn into the cooking chamber (1306) of the grilling device (100) through the aperture (828), the airflow imparts the flavor from the flavor enhancing material onto the food being cooked within the cooking chamber (1306) of the grilling device (100).

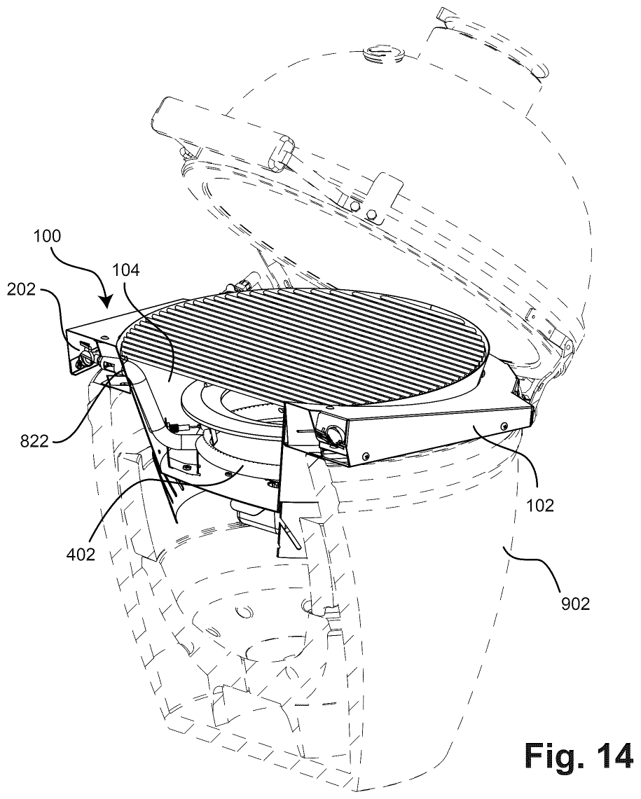

FIG. 14 shows the fuel supply system (202) as it exits the collar (102) and enters the bowl (104) through the opening (822) in the bowl (104). The fuel supply system (202) enters the bowl (104) and travels downward to supply fuel to the burner (402). The collar (102) is located at a first elevation. The burner (402) is located at a second elevation, which is below the first elevation. This configuration allows the grilling device (100) to fit in the cooker (902) and provide a grilling device cooking surface that closely aligns with the designed cooking surface of the cooker.

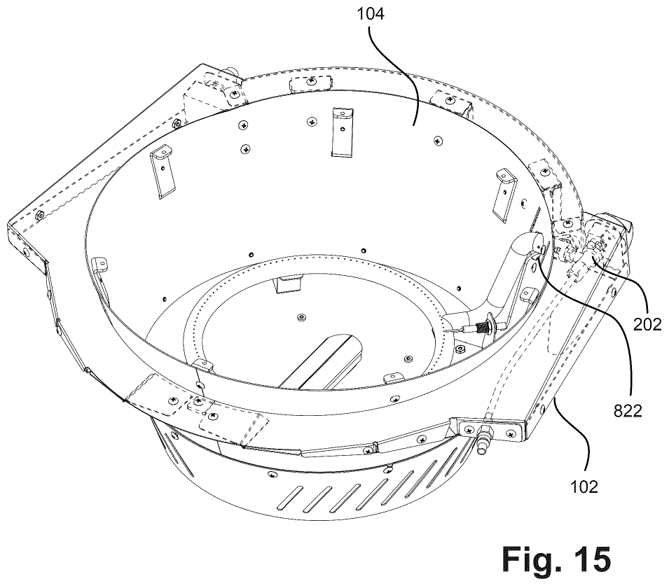

FIG. 15 shows the elevation change of the fuel supply system (202) as it exits the collar (102) and enters the bowl (104) through the opening (822) in the bowl (104).

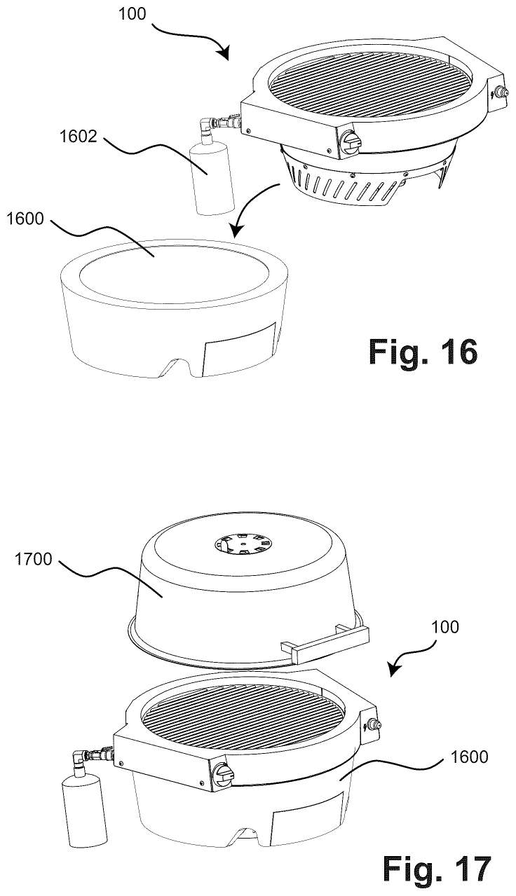

FIG. 16 shows the first step of inserting the grilling device (100) into a tabletop base accessory (1600), which provides a cosmetic finished appearance as well as added protection from the hot surfaces of the grilling device (100) when in use. Also shown in this illustration is the attachment of a portable propane gas cylinder (1602), ideal for transporting and using at a remote site such as a campsite or tailgate.

FIG. 17 shows the second step of inserting the grilling device (100) into the tabletop base accessory (1600). Also shown is a grill lid accessory (1700) used for enclosing the cooking surface and trapping in heat when cooking.

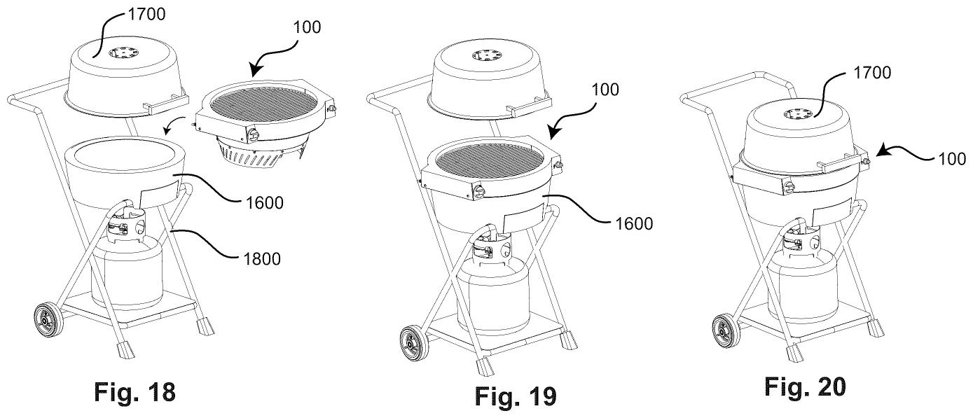

FIG. 18 shows the first step of inserting the grilling device (100) into a floor standing base. In one embodiment, the tabletop base accessory (1600) is connected to a base frame (1800). The grilling device (100) is inserted into the opening of the tabletop base accessory (1600). In this embodiment, the grill lid accessory (1700) is also utilized to enclose the cooking area of the grilling device (100). In some versions the grill lid accessory (1700) is attached to a point on the base frame (1800), allowing the lid to rotate, lift, or pivot up and away from the grilling device (100) and staying in position in this elevated state until lowered back down by the user.

FIG. 19 shows the second step of inserting the grilling device (100) into a floor standing base. This view shows the grilling device (100) resting in place in the tabletop base accessory (1600) and ready to accept food for cooking.

FIG. 20 shows the third step of inserting the grilling device (100) into a floor standing base. This view shows the grill lid accessory (1700) closed over the top of the grilling device (100) while cooking is in progress.

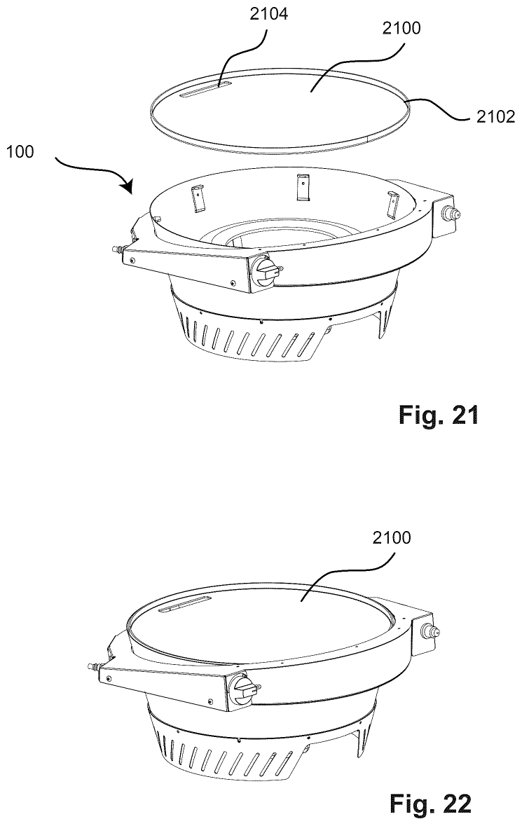

FIG. 21 shows the first step of attaching a griddle top (2100) according to an embodiment of the present disclosure. The griddle top (2100) replaces the wire grate (106), making the grilling device (100) suitable for cooking a variety of foods not typically cooked on the wire grate (106) such as eggs or pancakes. The griddle top (2100) is typically constructed from cast iron or sheet steel. The griddle top (2100) features a raised perimeter edge (2102) and a rear slit cutout (2104) to allow for controlled grease and cooking waste disposal.

FIG. 22 shows the second step of attaching a griddle top (2100) according to an embodiment of the present disclosure. This shows the resting position of the griddle top (2100) ready to accept food for cooking.

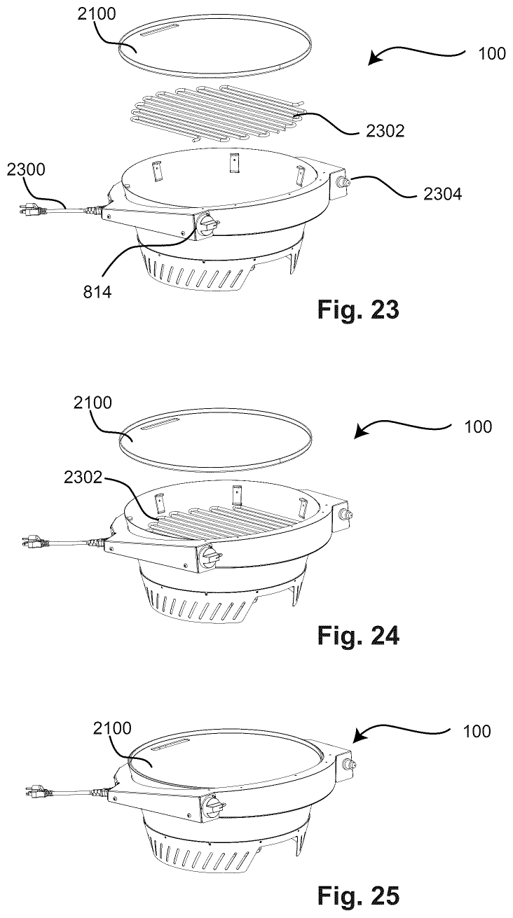

FIG. 23 shows an electric version of the grilling device (100) according to an embodiment of the present disclosure. The body structure of the grilling device (100) is similar to the gaseous fueled embodiment. One difference with the electric version is that the quick connect gas inlet has been replaced with an electrical supply cord (2300) leading to an internal circuit board. The circuit board, in conjunction with the control system (814), controls the heat supplied to an electric heating element (2302). The heat generated by the electric heating element (2302) transfers to the griddle top (2100). In one embodiment the push button igniter (816) is replaced with an on/off button or switch (2304), yet in others this button is replaced with a secondary heat control system for an additional independently controlled cooking zone.

FIG. 24 shows an electric version of the grilling device (100) according to an embodiment of the present disclosure. This shows the resting position of the electric heating element (2302) prior to placing the griddle top (2100) in position.

FIG. 25 shows an electric version of the grilling device (100) according to an embodiment of the present disclosure. This shows the resting position of the griddle top (2100) ready to accept food for cooking.

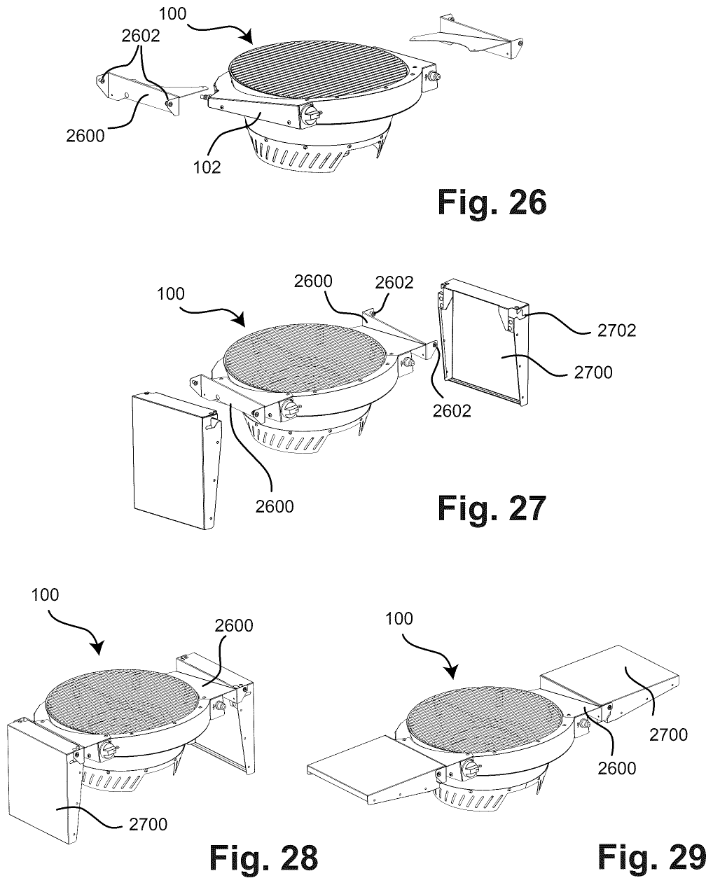

FIG. 26 shows the first step of connecting one or more foldable side shelves to the grilling device (100) according to an embodiment of the present disclosure. In order to utilize the side shelves, a side shelf bracket (2600) is first mechanically fastened to the collar (102). The side shelf bracket (2600) features a set of extended bolts and nuts (2602) with cylindrical exterior surfaces that allow for hanging attachment points for the side shelves.

FIG. 27 shows the side shelf brackets (2600) connected to the grilling device (100) according to an embodiment of the present disclosure. After the side shelf brackets (2600) are connected to the grilling device (100), the side shelf (2700) can be hung from the set of extended bolts and nuts (2602) from an outer edge cutout (2702) on the side shelf (2700).

FIG. 28 shows the foldable side shelves (2700) connected to the grilling device (100) according to an embodiment of the present disclosure. In this view the side shelves (2700) are connected to the side shelf brackets (2600) in their stored position.

FIG. 29 shows the side shelves (2700) connected to the grilling device (100) according to an embodiment of the present disclosure. In this view the side shelves (2700) are connected to the side shelf brackets (2600) in their operable position, ready for placement of cooking utensils, food, dishes, etc.

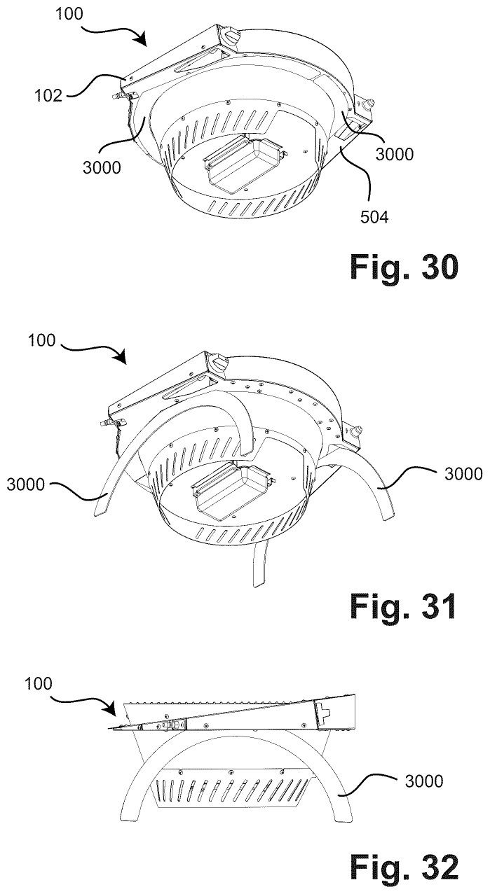

FIG. 30 shows a set of foldable legs (3000) connected to the lower surface (504) of the collar (102). The foldable legs (3000) provide additional elevation of the grilling device (100) from a resting surface, which decreases heat transfer to a tabletop or other resting surface. In this figure, the foldable legs (3000) are shown in the recessed position.

FIG. 31 shows the foldable legs (3000) connected to the grilling device (100) and extended.

FIG. 32 shows the foldable legs (3000) connected to the grilling device (100) and extended, supporting the grilling device (100).

While preferred materials for elements have been described, the device is not limited by these materials. Wood, plastics, rubber, foam, metal alloys, aluminum, ceramic, and other materials may comprise some or all of the elements of the grilling device devices, accessories, and apparatuses in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated there-by, and are intended to be covered by this disclosure.

I claim:

1. A grilling device configured to be removably coupled to a cooker, wherein the cooker utilizes a first fuel type, the grilling device comprising:
a bowl;
a heating apparatus utilizing a second fuel type different than the first fuel type; and
a collar surrounding the bowl, wherein the collar houses components of the heating apparatus, and wherein the collar includes a lower surface configured to interface a sealing rim of the cooker and and upper surface configured to interface a lid of the cooker.

2. The grilling device of claim 1, wherein the heating apparatus comprises:
a fuel supply system which is connected to the second fuel type and positioned within the collar;
a heater positioned in the bowl and connected to the fuel supply system; and
a control system connected to the fuel supply system and configured to control a flowrate of the second fuel type provided to the heater.

3. The grilling device of claim 2, wherein the bowl includes a sidewall having an upper edge and a lower edge, and wherein a cooking surface is positioned adjacent the upper edge of the sidewall.

4. The grilling device of claim 3, wherein a bowl bottom is connected to the sidewall adjacent the lower edge, and wherein the bowl bottom is sloped downward to an aperture.

5. The grilling device of claim 3, wherein a trim ring is attached to the lower edge of the sidewall.

6. The grilling device of claim 2, wherein the collar is provided at a first elevation, wherein the heater is provided at a second elevation below the first elevation, and wherein the fuel supply system is configured to direct the second fuel type to the heater at the second elevation.

7. The grilling device of claim 6, wherein the first elevation is spaced from the second elevation by spaced apart by a predetermined distance sufficient to promote downward fuel flow.

8. The grilling device of claim 2, wherein the fuel supply system comprises tubing and a valve.

9. The grilling device of claim 2, wherein the heater is a gas burner.

10. The grilling device of claim 9, further comprising an ignition system, the ignition system comprising a push button igniter, an electrode wire, and a spark generating electrode, wherein the push button ignitor is connected to the electrode wire and the electrode wire is connected to the spark generating electrode which is mounted near the burner.

11. The grilling device of claim 2, wherein the fuel supply system is an electrical supply cord.

12. The grilling device of claim 11, wherein the heater is an electric heating element.

13. The grilling device of claim 1, wherein the lower surface and the upper surface of the collar are non-parallel.

14. The grilling device of claim 1, wherein the lower surface and the upper surface of the collar are parallel.

15. The grilling device of claim 1, wherein the first fuel type is one of charcoal, wood, pellets, or electricity.

16. The grilling device of claim 1, wherein the second fuel type is one of gaseous fuel or electricity.

17. The grilling device of claim 1, further comprising one or more side shelves attached to the collar.

18. The grilling device of claim 17, wherein each side shelf connects to a side shelf bracket on the collar, and wherein each side shelf is configured to move between a stored position and an operable position.

19. The grilling device of claim 1, wherein the bowl is configured to receive an airflow from a flavor-enhancing chamber in the cooker, wherein the airflow comprises a flavor-enhancing material absorbed in the flavor-enhancing chamber.

20. A method of cooking, the method comprising the steps of:
positioning a grilling device in a cooker, the grilling device including a bowl, a heating apparatus, and a collar surrounding the bowl, wherein a lower surface of the collar interfaces a sealing rim of the cooker;
operating the heating apparatus; and
closing a lid of the cooker such that an upper surface of the collar interfaces the lid of the cooker.
